(19) United States
(12) Patent Application Publication
(10) Pub. No.: US 2018/0179817 A1
(43) Pub. Date: Jun. 28, 2018

(54) PORTABLE LADDER AND ROLLING SHAFT

(71) Applicant: Juan Sebastian Almada, Beccar (AR)

(72) Inventor: Juan Sebastian Almada, Beccar (AR)

(21) Appl. No.: 15/842,452

(22) Filed: Dec. 14, 2017

(30) Foreign Application Priority Data
Dec. 27, 2016 (AR) P 160104020

(51) Int. Cl. E06C 1/397; E06C 1/383; E06C 7/06; E06C 1/14

(52) U.S. Cl. CPC E06C 1/397; E06C 1/14; E06C 7/06; E06C 1/383

(57) ABSTRACT

A portable ladder and rolling articulated shaft for articulated ladders, which facilitate the transportation of the ladder together with various goods and elements, in order to optimize operating times and prevent users from performing multiple travels to move goods.

### BACKGROUND OF THE INVENTION

### 1. Field of the Invention.

The present invention relates to the field of portable ladders, and more particularly the invention relates to a device for said ladders, which facilitates transportation and mode of operation thereof, as well as, it allows to optimize available physical spaces when it is moved and times of operation, wherein in turn, it is provided with an rolling articulated shaft that facilitates moving said ladders. Even when in the present description reference is made to a device and rolling articulated shaft for portable ladders of the articulated type, this does not imply that the invention is limited thereto, but that the device and the shaft of this invention can be adapted and used in any type of portable ladder without any inconvenience.

### 2. Description of the Prior Art.

Portable ladders are well known in the field of the art and, it is known that they allow people to go up/go down to/from inaccessible places because of being at a different height or level. Portable ladders allow people to perform, in addition to the ascent/descent to/from inaccessible places, multiple tasks such as accommodating objects, installing different components for home, performing the maintenance of equipment, facilities, and many other tasks among many others. Generally, it is composed of two longitudinal beams of variable length joined transversely through steps arranged in an equidistant way that allow the progressive ascent to the desired zone. Ladders are usually easily transportable due to their lightness. In its beginnings, they were made of wood and currently the most used material is aluminum due to its lightness and because it allows more joints between steps and beams of greater stability, thus prolonging the useful life of the ladder.

While there are countless types of ladders that adapt to the needs of each user, there are still a number of drawbacks. One of these drawbacks occurs when the user is an operator who hast to move, not only the ladder but also various work tools. If the user moves in a transporting vehicle, and if the workplace is far from where the vehicle is parked, the user must first take the ladder to the workplace, return to the transporting vehicle to pick up the necessary tools and so repeatedly depending on how many tools or objects the user may need. This implies that the user has to make multiple travels, with noticeable losses of time and an additional physical effort that during a full working day, can be harmful to his/her health. Likewise, portable ladders must be carried on the “shoulder” for transportation. This also implies that, during a full working day, the person has to make an additional effort that can be harmful to his/her health. That is, the user not only should perform multiple travels to move the tools and ladder, but also, the user should make physical efforts that may affect the user's health in the short term.

U.S. Pat. No. 5,086,872 discloses a portable ladder equipped with a wheeled shaft that can be screwed on a step of the ladder to facilitate transportation of the ladder and convert it into a cart for transportation of goods. While the addition of wheels is a well known resource, this kind of wheeled shaft is not practical because it is stationary in its position and needs of the use of tools to install and remove it in/from a ladder. In addition, while the ladder is disclosed as being capable of transporting goods it seems that the goods must have a big dimension or being attached firmly to the ladder to prevent the goods from falling down the cart.

In view of the foregoing, it would be advisable to have a new arrangement that may facilitate moving portable ladders as well as, may avoid multiple travels to move tools and ladders, and avoid additional physical effort which is harmful to people.

### SUMMARY OF THE INVENTION

It is therefore an object of this invention to provide a new device for portable or manual ladders, which facilitates their moving, optimizing physical spaces and operating times.

It is still another object of this invention to provide a device designed to facilitate and improve the move of various work tools in conjunction with the ladder.

It is still another object of this invention to provide a device that prevents the user from repeatedly making the same travel to move the ladder and the tools, as well as avoiding additional physical effort that is detrimental to the health of the people.

It is also another object of this invention to provide a device for portable ladders of the type comprising beams which are articulated and interconnected by a plurality of steps which are arranged transversely thereto and spaced at a distance from each other, wherein said beams are articulated and pivot around at least one articulation point to allow the ladder to be between at least one folded position and at least one extended position, wherein said device comprises at least one box provided with respective side handles that is arranged, when the ladder is in the folded position, between the spaces defined by the separation distance between steps, at least one lateral carrying handle provided on at least one of the sides of the beams, at least one removable front carrying handle, at least one rolling articulated shaft provided with respective wheels that are arranged on each side of the ladder, and also being provided with a reinforced hinge having a locking arrangement at each of the articulation points of the beams.

It is still another object of this invention to provide an rolling articulated shaft for articulated ladders of the type comprising aluminum beams articulated at different points of articulation which are provided with respective reinforced hinges having locking arrangement, a plurality of aluminum steps of hollow profile that are arranged separated from each other and transverse to the beams, said steps extending from each side thereof in order to define a through internal guide that has an inlet on each side of the ladder and wherein said rolling articulated shaft comprises a hollow main profile that extends longitudinally and inside one of the through internal guides defined by the hollow profile of each step, respective lateral arms that are arranged on each side of the main profile and each having a proximal end which is partially arranged inside the hollow main profile and which is provided with a cylindrical shaft, and a distal end which is connected to a respective leg of a wheel, said side arms being connected to each other by a fixed spring between the respective cylindrical shafts provided at the proximal end of each lateral arm.

### BRIEF DESCRIPTION OF THE DRAWINGS

The present invention is illustrated by way of example in the following drawings wherein:

FIG. 1 shows a side view of the device of the present invention used in an articulated ladder which is folded;

FIG. 2 shows a perspective view of the device of the invention and articulated ladder of FIG. 1;

FIG. 3 shows a perspective view of the articulated ladder in conjunction with a rolling articulated shaft according to the present invention, wherein the extended ladder can be observed;

FIG. 4 shows a view of rolling articulated shaft for articulated ladders according to the present invention;

FIG. 5 shows a partial sectional view of the rolling articulated shaft of the present invention;

FIG. 6 shows an exemplary view of a possible use of the ladder of the present invention;

FIG. 7 shows an exemplary view of another possible use of the ladder, device and shaft according to the present invention;

FIG. 8 shows an exemplary view of yet another possible use of the ladder, device and shaft of the present invention;

FIG. 9 shows an exemplary view of a possible use and position of the ladder, device and shaft according to the present invention;

FIG. 10 shows an exemplary view of yet another possible use and position of the ladder, device and shaft according to the invention;

FIG. 11 shows a perspective view of a front carrying handle according to the present invention;

FIG. 12 shows a partial sectional view of a portion of the front carrying handle of FIG. 11, which is embedded in a portion of the ladder according to the present invention; and

FIG. 13 shows a perspective view of an alternative of the device used on an articulated ladder according to the present invention.

### DESCRIPTION OF THE PREFERRED EMBODIMENTS

Referring now to the figures, it can be seen that the invention consists of a novel device for portable ladders that facilitates their moving, as well as the joint move of various work tools without the need for repeated travels. Although aluminum articulated portable ladders have been illustrated and referred to in the present invention, this does not imply that the present invention is limited thereto, but that the invention can be modified, adapted and used in different types of ladders without any inconvenience.

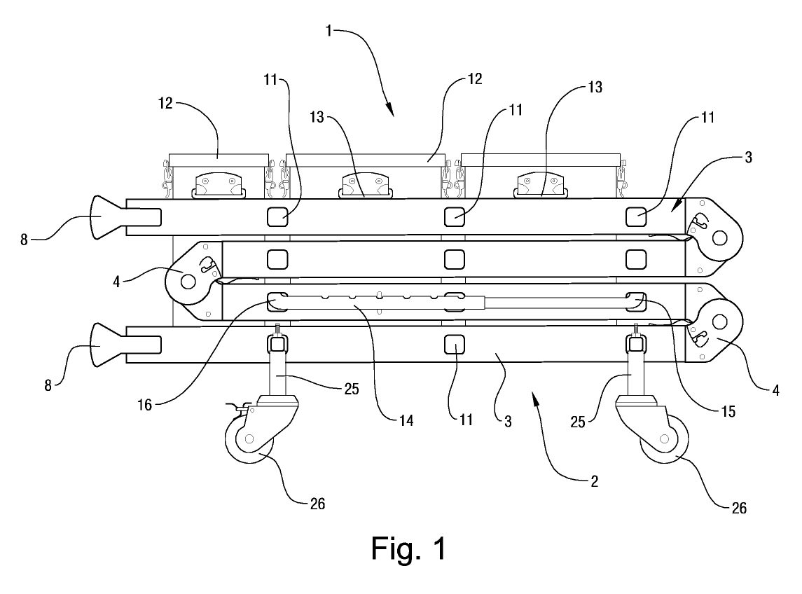

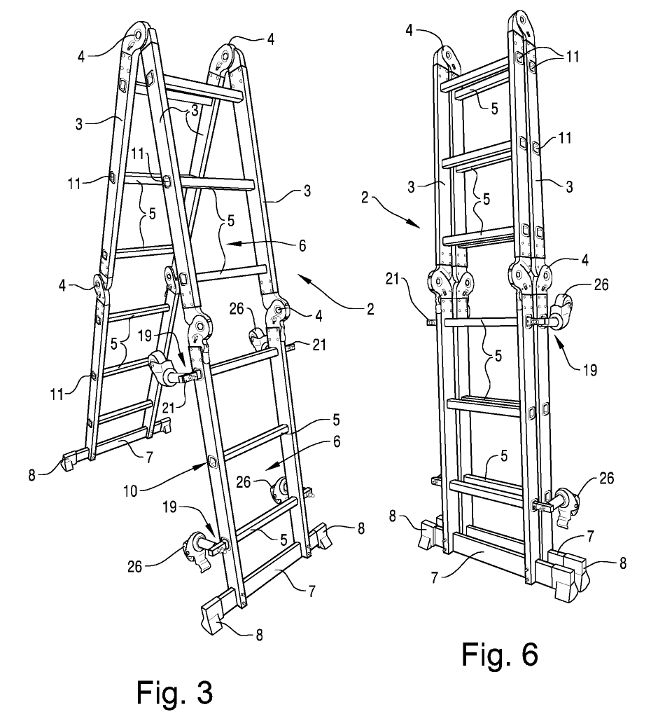

Thus, and according to FIGS. 1 to 12, the device of the present invention is indicated by the general reference 1 and is used for articulated portable ladders 2 which generally comprise a pair of articulated aluminum beams 3, which are articulated and pivot, around hinge points provided with respective reinforced hinges having locking arrangement 4 to allow the ladder to be between at least one folded position and at least one extended position. It is known that the reinforced hinges having locking arrangement 4 provide greater security and stability to the structure of ladders and are well known in the field of the art, and that for such reasons, descriptive details about the operation and composition thereof will not be detailed. Likewise, beams are interconnected by a plurality of steps 5 which are arranged transversely thereto and are separated equidistant from each other. As can be seen in FIG. 3 and as it is known in the field of the art, the spaces 6 defined between step and steps define different levels of heights.

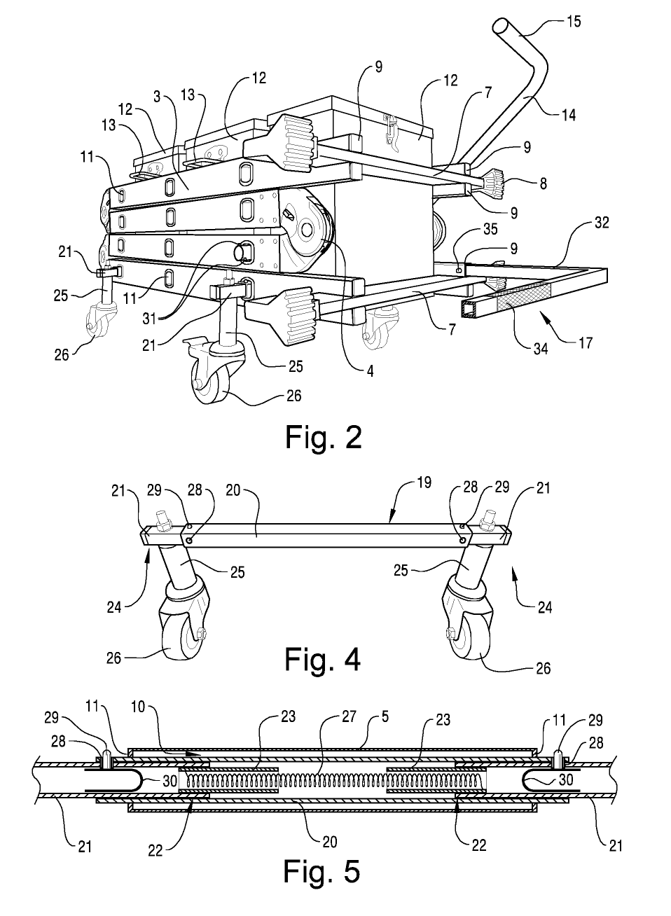

On the other hand, the aluminum beams 3 have at one of their end a pair of anti-slip shoes 7 which are provided with respective anti-slip rubber pads 8. As can be seen in FIG. 2, the shoes 7 divide the lower end of the beams 3 into two parts, thus defining a pair of hollow inlets 9 which can be covered or not, by respective rubber pads. For their part, said steps 5 can have a n anti-slip material on one of their faces to provide greater security when the person is thereon and can be hollow profiles that extend from each side of the beams 3, the interior of each of the steps 5 defining a through internal guide 10 with an inlet 11 arranged on each outer side of the beams 3. It should be noted that both the beams, steps and shoes can be made of aluminum, this being not limiting for the invention, since other types of materials can also be considered and used for the invention without any inconvenience.

For its part, the device 1 of the present invention comprises at least one box 12 provided with respective side handles 13 that is arranged, when the ladder is in folded position, between the spaces 6 defined between steps 5, as best illustrated in FIG. 1. The box 12 can be a tool box, a carrying case or the like, wherein side handles 13 are locked against the beams in order to prevent the boxes from falling when they are moved in conjunction with the ladders. It should be noted that the boxes 12 can be made of sheet metal or any material suitable for the storage of various tools and related components, and that the boxes, when being moved, are protected from impacts and/or possible damages, since they are introduced in the spaces between steps and beams.

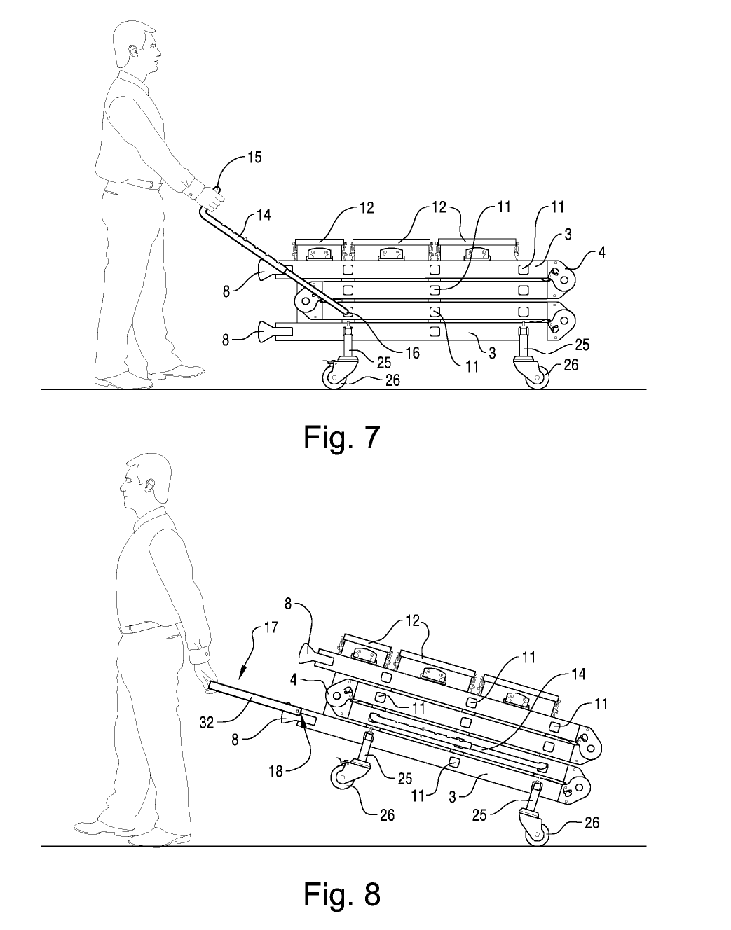

Likewise, the device of the invention has at least one lateral carrying handle 14 disposed on at least one of the sides of the beams 3. Said lateral carrying handle 14 is an adjustable pivoting handle having a distal end 15 and a proximal end 16 which is mounted inside a through internal guide 11 and removably retained/fixed by a pair of lugs 31 that are arranged opposite each other and beyond the outer side of the beams, operatively locking against the lip or edge of the inlet 11. In the extended position of the ladder, the distal end 15 of the lateral carrying handle 14 is within another inlet 11 of through internal guide 11, that is, it is “stored” to avoid possible accidents, the lugs 31 being aligned in a vertical position to prevent the side handle from moving or “coming out” inadvertently. While, in said folded position of the ladder, the distal end 15 is “free” and fixed in a predetermined position to facilitate the grip and move of the ladder, as best illustrated in FIG. 7. If the user wishes so, the user can remove the side carrying handle 14 by arranging the lugs at the corners of the inlet 11. That is, the user must turn the side handle 14, until the lugs align diagonally and are disposed adjacent to the corners of the inlet 11. When the lugs 31 are adjacent and parallel to the corners of the inlet 11, the side handle 14 is pulled so that the lugs 31 retract and thus allow the release thereof. It is emphasized that, in the folded position of the ladder, the side handle 14 can be arranged in the “rear” or “front” part, according to the comfort and necessity of each user.

Alternatively, the present invention can have at least one removable front carrying handle 17 having respective arms 32 interconnected by a crosspiece 33 which has a gripping area 34, the ends 18 of the arms 32 being removably engaged or they mount on the hollow inlets 9 of the beams 3 defined on each side of the shoes 7, as best illustrated in FIG. 8. The engaging system between the front handle and the hollow inlets, can be by means of lugs 35 provided in the proximities of the ends of the arms 32 that operatively engage in the respective holes 36 made in at least one of the faces of the hollow inlets 9 of the beams 3. The arms 32 can be hollow profiles, while the lugs 35 are retained within said arms 32 by a metal plate 37 interconnecting them, as best illustrated in FIG. 12. In this way, the front carrying handle can be removed by pressing/squeezing the lugs and pulling the front handle to release it from the ladder. Although a locking system has been described and illustrated by means of lugs and holes, this does not imply that the invention is limited thereto, but that any type of system well known in the field of art can be used without any inconvenience. Likewise, the front carrying handle can have any type of structural configuration, which may be comfort for the user without any inconvenience, the invention not being thus limited to the configuration illustrated in FIG. 11.

On the other hand, to facilitate and be able to carry out, the movement of the ladder, at least, one rolling articulated shaft 19 is provided, which comprises at least one hollow main profile 20 extending longitudinally and inside one of the internal guides 10 defined the hollow profile of each step 5. Likewise, there are respective movable side arms 21 which are arranged on each side of the main profile 20 and each having a proximal end 22 which is arranged partially inside the hollow main profile and which is provided with a cylindrical shaft 23, and a distal end 24 which is connected to a respective leg 25 of a wheel 26. According to FIG. 5, said side arms 21 are connected to each other by a spring 27 fixed between the respective cylindrical shafts 23 provided at the proximal end 22 of each side arm 21.

On the other hand, said main profile 20 and side arms 21 have a plurality of holes 28 coincident with each other, while, each of the proximal ends 22 of the side arms 21, has at least one lug 29 that passes through the holes 28 coinciding and made in the main profile and in the side arms. In this way, structural unity is achieved between the side arms and the main profile by means of the locking system achieved by the lug in the holes and the retention by the spring. It should be noted that the lug 29 is connected to a “C” plate 30 which is retained under pressure inside the inner section of the side arm 21, while the legs 25 of the wheels 26 are fixed to the side arms 21 on a perpendicular way. Although, it has been illustrated that the legs 25 are fixed by means of a screw-bolt threaded system, this does not imply that the invention is limited thereto, but the connection between parts can include welded joints, articulated joints, bolts, etc.

It is noted that each of the wheels 26 is disposed on each side of the ladder and can be steerable, guided wheels or the like. Likewise, side arms are mobile and are retained in the main profile by the lug and the action of the spring. However, when the lug is pressed to release the respective side arm, each of the side arms is able to articulate and rotate in any direction independently of one another. In this way, said side arms can rotate by arranging the wheels between movement and guard positions according to the needs of the user. By having the plurality of holes 28, the lug 29 of each side arm 21 is operatively engaged therein to improve safety of assembly forming the articulated shaft. Although at least one rolling articulated shaft has been mentioned, two or more rolling articulated shafts can be provided depending on the length of each beam and the total length of the ladder in order to facilitate its moving. At the same time, as the wheels are arranged on each side of the beams, preferably at the outer side of the beams, and side arms are articulated, they allow the user to use all possible positions, without this causing a nuisance at the time of going up and down the steps.

It should be noted that the parts that make up the articulated shaft can be made of aluminum, iron, or any related material capable of supporting the weight of the ladder and its components without bending due to stress.

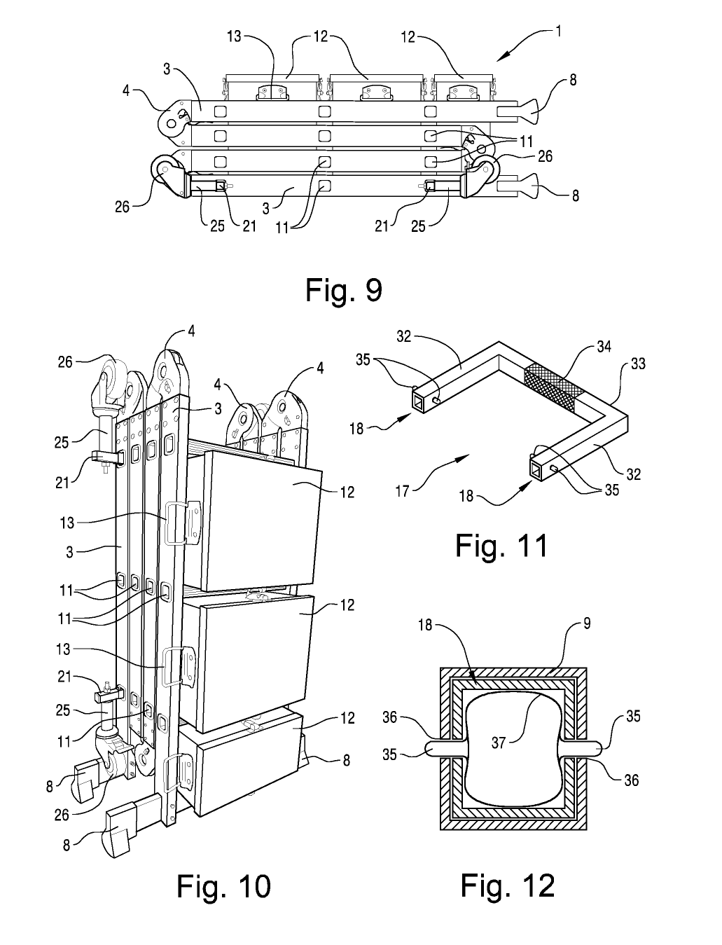

In this way, the device of the present invention is constituted and constructed, wherein the user no longer has to repeat the same travel several times to pick up and move the work tools as well as the ladder. Also, by having the rolling articulated shaft, the user is prevented from making physical efforts that may affect the user's health. According to the present invention, in operational mode or in extended position, the ladder can be arranged in various ways, whether in scissor mode, bent mode, multipurpose mode, etc., as illustrated by way of example in FIGS. 2 and 6. While, in inoperative or folded position, the ladder can be arranged in various ways, as best illustrated in FIGS. 9 and 10. In. FIG. 9, there is illustrated the folded ladder to be moved, for example, in the box of a transport vehicle, this not being limited for the invention, since said arrangement of the parts can be used at any time/situation and not necessarily when it is moved in the box of a vehicle such as a cargo van. Thus, and as can be seen from FIG. 9, the side arms are articulated so that the wheels are perpendicular to the floor, the ladder resting on the floor, either of the box or a place, by means of the beams, avoiding in this way possible involuntary slides. In FIG. 10, the ladder is folded in such a way that it is resting on the shoes. On the other hand, and by way of example, the ladder of the present invention can be moved by the side handle, FIG. 7, or by the front handle, FIG. 8. Either of the two options can be used without any inconvenience for the user.

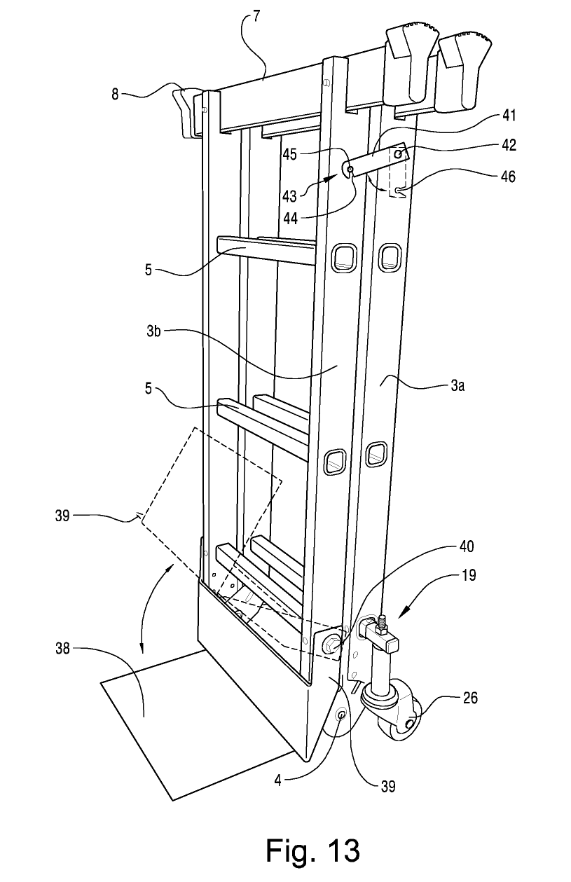

According to FIG. 13, an alternative of the device of the present invention can be provided, wherein the articulated portable ladder 2 can have two sections instead of four as described above, this not being limited for the invention since the number of sections will depend on the needs of each user. According to FIG. 13, at stacking ray 38 in the form of an “L” is provided, from which the respective connecting side arms 39 extend which are arranged on each side of a portion of the beams 3. The stacking tray 38 is connected to the ladder through a connecting arm (not shown) that passes inside the step 5 and at the ends of which respective fixing screws 40 are threaded that pass through holes made on each of the connecting side arms 39 and that are adjusted so as to generate a secure link between the tray and the ladder.

In this way, when the ladder 2 is folded, FIG. 13, the tray 38 has the horizontal part parallel to the floor allowing stacking and movement of tool boxes, boxes or the like, so as to provide greater comfort for the individual. In order to carry out the movement of the ladder, the user should only hold onto the shoes 7 and begin the movement. When the ladder is unfolded, it is sufficient to slightly loosen each screw 40, pivot the tray to a position where it does not bother the person and then adjust it again so that it is not “loose”. By presenting a design in the form of “L”, the tray ensures that the individual can carry out operations properly without risk or discomfort. The reverse procedure must be carried out when the work is finished and you want to move the ladder along with the arrangements or related elements. However, depending on the position in which it is located, the tray can also be used as support for tools or related elements during the operation processes.

Likewise, to provide greater security when the ladder is moved or when it is not used, and to prevent it from opening, a locking means 41 is provided in the form of a plank that has at least one fixed pivot end on a beam 3a by means of a screw 42 and a free end 43 in the form of a “hook” which has a cutout 44 that fits and is in operative contact against a fixed screw 45 in another beam 3b. That the screw 45 is threadedly fixed on the beam 3b, and the cutout 44 of the free end 43 fits against it so that adjusting the screw 15 ensures the connection between the beams 3a and 3b through the plank, and consequently, the involuntary opening of the ladder is avoided.

It is emphasized that the screws 42 and 45 are fixed in conjunction with respective nuts and a third plank locking screw 46 can be provided, in the same beam in which the screw 42 is located and adjacent to the latter, so that when the ladder is unfolded, the plank is not “loose”. In turn, it is understood that the ladder 2 illustrated in FIG. 13 also has reinforced hinges with locking arrangement 4, shoes 7, and rolling articulated shaft 19 to facilitate the movement thereof.

Thus, the user only makes a single travel to move, for example, the ladder from the transport vehicle to the place where the user must work. Likewise, being a ladder of the articulated type, physical spaces are optimized. In this way, operation times are also optimized and the physical effort that the person should make is reduced. It should be noted that the novel structural configuration of the present invention can be adapted and used in any type of ladder whether it has a greater or lesser number of steps and/or sections without any inconvenience.

I claim:

1. A portable ladder comprising:
beams articulated at different points of articulation, with each articulation comprising a reinforced hinge with locking arrangement, wherein said beams are articulated and pivot around at least one point of articulation to move the ladder between at least one folded position and at least one extended position,
a plurality of steps transversely extending between the beams, each step comprising a hollow profile defining a through internal guide that has an inlet on each end of the step and at an outer side of a corresponding beam,
a rolling articulated shaft inserted inside the through internal guide of one of the steps, the shaft comprising pivoting wheels with one wheel at each outer side of the beams, the wheels being capable of being pivoted between a rolling position and a resting position.

2. The ladder of claim 1, further comprising:
at least one box inserted between two adjacent steps when the ladder is folded,
at least one carrying handle provided on at least one of the beams.

3. The ladder of claim 1, wherein said rolling articulated shaft comprises:
a hollow main profile that extends longitudinally and inside one through internal guide of one of the steps,
respective side arms, each arm being arranged at one end of a pair of opposite ends of the hollow main profile and each arm having a proximal end which is partially arranged inside the hollow main profile and which is provided with a cylindrical shaft, and a distal end that is connected to a respective rotatable leg of a wheel.

4. The ladder of claim 1, wherein said carrying handle is a side pivoting carrying handle having a distal end and a proximal end, the proximal end being mounted inside a through internal guide inlet.

5. The ladder of claim 4, wherein in said extended position of the ladder, the distal end of the side carrying handle is located inside another through internal guide, while, in said folded position, the distal end is free and fixed in a predetermined position.

6. The ladder of claim 1, wherein said carrying handle is an extendable front carrying handle that has distal ends that are mounted in respective hollow inlets of the beams defined close to shoes of the ladder.

7. The ladder of claim 1, further comprising a pair of non-slip shoes provided at respective side ends of the beams, said beams comprising hollow profiles that are divided into two parts in the area of the shoes, thus defining at least one pair of hollow inlets on each side thereof.

8. The ladder of claim 1, wherein said rolling articulated shaft passes through a through internal guide of another step, each of the wheels being disposed on each side of the ladder.

9. A rolling articulated shaft for portable ladders, the ladder comprising beams articulated at different points of articulation that are provided with respective reinforced hinges with locking arrangement, a plurality of steps transversely extending between the beams, each step comprising a hollow profile defining a through internal guide that has an inlet on each end of the corresponding beam, said rolling articulated shaft comprising:
hollow main profile that extends longitudinally and inside one through internal guide of one of the steps,
respective side arms, each arm being arranged at one end of a pair of opposite ends of the hollow main profile and each arm having a proximal end which is partially arranged inside the hollow main profile and which is provided with a cylindrical shaft, and a distal end that is connected to a respective rotatable leg of a wheel.

10. The shaft of claim 9, wherein said side arms being connected to each other by a fixed spring between the respective cylindrical shafts provided at the proximal end of each side arm.

11. The shaft of claim 9, wherein said main profile and lateral arms have a plurality of holes coinciding with each other, while, each of the proximal ends of the lateral arms, has at least one lug which passes through the coinciding holes made in the main profile and in the lateral arms.

12. The shaft of claim 9, wherein the legs of the wheels are perpendicular to the lateral arms.

13. The shaft of claim 9, wherein said lateral arms and legs are rotatably to move the wheels between movement and guard positions.

14. The shaft of claim 9, wherein at least two rolling articulated shafts are provided for a same ladder.
